(19) United States
(12) Patent Application Publication
(10) Pub. No.: US 2009/0047453 A1
(43) Pub. Date: Feb. 19, 2009

(54) NANO-ENHANCED SMART PANEL

(75) Inventors: Robert Folaron, Plano, TX (US); James Wylde, Oak Leaf, TX (US); Tobin Djerf, Grand Saline, TX (US)

Correspondence Address: FIALA & WEAVER, P.L.L.C.;C/O INTELLEVATE, P.O. BOX 52050, MINNEAPOLIS, MN, 55402, US

(73) Assignee: SMART NANOMATERIALS, LLC, Plano, TX (US)

(21) Appl. No.: 12/189,696

(22) Filed: Aug. 11, 2008

Related U.S. Application Data
(60) Provisional application No. 60/955,447, filed on Aug. 13, 2007.

(51) Int. Cl. B32B 5/18; B32B 5/16; B32B 37/00

(52) U.S. Cl. 428/34.1; 428/221; 428/323; 156/60; 156/280

(57) ABSTRACT

Methods, systems, and apparatuses are provided herein for a smart panel. In embodiments, the smart panel is assembled to be lightweight, while being stiff, strong, flexible, and/or tough. The smart panel may include one or more functions, such as power generation, power storage, wireless communications capability, memory, one or more sensors, a display for graphics/video, being enabled to programmatically change colors, and/or further functions. In an embodiment, the smart panel is a multilayered panel, assembled from one or more materials. The materials may be optionally enhanced with micro-scale and/or nano-scale technologies/components.

This application claims the benefit of U.S. Provisional Application No. 60/955,447, filed on Aug. 13, 2007, which is incorporated by reference herein in its entirety.

### CROSS-REFERENCE TO OTHER APPLICATIONS

The following applications of common assignee are related to the present application, were filed on the same date as the present application, and are herein incorporated by reference in their entireties:

U.S. Application No. [to be assigned], titled “Nano-Enhanced Modularly Constructed Composite Panel,” and

U.S. Application No. [to be assigned], titled “Nano-Enhanced Modularly Constructed Container.”

### BACKGROUND OF THE INVENTION

1. Field of the Invention

The present invention relates to the construction of composite panels, and more particularly to modularly constructed composite panels having functionality aspects formed therein.

2. Background Art

A need exists for lightweight durable materials. Such durable materials may be needed for various reasons, such as a need to provide resistance to mechanical, thermal, chemical, and/or other environmental phenomena, and/or to address further requirements for durability. A wide variety of applications may benefit from materials that have such durability. Examples of such applications include vehicles, shipping and storage containers, aircraft skins, clothing (e.g., armor worn by security, law enforcement, military, and/or other personnel), structural applications, and further applications. Applications that require movement of materials would benefit from materials having a decreased weight. For instance, items such as vehicles (e.g., delivery trucks, trains, etc.), shipping and storage containers, protective doors require the expenditure of energy for the purpose of movement, and therefore would benefit from lighter weight materials. Further applications can benefit from lighter weight in order to increase the efficiency of the system, e.g., wind turbine blades, propellers, etc. Thus, what is desired are materials that are lightweight and durable, and that may be used in a variety of applications.

Furthermore, many applications, including vehicles, shipping containers, storage containers, aircraft skins, clothing, protective doors, wind turbine blades, structural applications, and further applications, would benefit from additional functionality. Such functionality may include greater intelligence, sensors, and further types of functionality. However, such additional functionality may result in a higher cost to an application and/or an increase in required space. Thus, what is desired are ways of providing additional functionality to applications in a manner that does not significantly increase costs and that is spatially efficient.

### BRIEF SUMMARY OF THE INVENTION

Methods, systems, and apparatuses are provided herein for a “smart” panel. The smart panel is durable, may be lightweight, may include one or more incorporated functions, and may be relatively easy to construct.

In one implementation, a smart panel includes a plurality of layers arranged in a stack, a nanomaterial, and one or more functional elements. The nanomaterial is dispersed in a material of at least one layer of the plurality of layers. The functional element(s) is/are included in one or more layers of the plurality of layers.

Each layer in the stack may include one or more of a woven material, a cured foam material, a plurality of solid rods, or a plurality of hollow tubes. An adhesive material may be present between one or more layers in the stack to adhere the layers together. The smart panel may include a layer that configured to provide protection for the panel.

A variety of functional elements may be included in one or more layers of the stack, such as a power generator, a storage device, a communication module, a heat generator, a display, a microcontroller, and/or a sensor. A layer may include an array of functional elements, such as an array of sensors.

In another implementation, a method of fabricating a smart panel is provided. A plurality of layers is formed, including the forming of one or more layers that include at least one functional element, and the forming of at least one layer that includes a nanomaterial. Any number of functional elements and/or nanomaterials may be included in one or more layers, including arrays of functional elements and/or nanomaterials. The plurality of layers is attached together in a stack.

For instance, the plurality of layers may be compressed together to form the stack. Additionally and/or alternatively an adhesive material may be inserted between layers of the stack, and the adhesive material may be cured to attach together the layers. In one example, a plurality of layers may be joined (e.g., foamed) together during a monolithic panel forming process.

Layers of the smart panel may be formed in various ways. One or more of the layers may be formed to include a woven material, a plurality of solid rods, or a plurality of hollow tubes. In an example, a resin material may be inserted into a mold. A catalyst material may be added to the resin material, or another catalyzing technique may be used, to cause a foam material to be produced that conforms to the shape of the mold. The foam material hardens to form a layer. The foam layer may be formed as an adhesive layer between other layers to attach together multiple layers during the hardening process.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a perspective exploded view of a panel, according to an embodiment of the present invention.

FIG. 2 shows a perspective side view of the panel of FIG. 1, in assembled (non-exploded) form, according to an embodiment of the present invention.

FIG. 3A shows a block diagram of a panel that includes functional elements, according to an embodiment of the present invention.

FIG. 3B shows an example panel that includes functional elements, according to an embodiment of the present invention.

FIGS. 4A-4C show cross-sectional views of an example panel, according to an embodiment of the present invention.

FIG. 5 shows a perspective exploded view of a multi-layer panel that includes rods, according to an embodiment of the present invention.

FIG. 6 shows a perspective side view of the panel of FIG. 5, in non-exploded form, according to an embodiment of the present invention.

FIG. 7 shows a perspective side view of a panel that includes rods, according to an example embodiment of the present invention.

FIG. 8 shows a cross-sectional view of a panel that includes rods, according to an example embodiment of the present invention.

FIG. 9 shows a perspective exploded view of a panel having layers formed from multiple co-planar layer sections, according to an embodiment of the present invention.

FIG. 10 shows a perspective side view of the panel of FIG. 9, in non-exploded form, according to an embodiment of the present invention.

FIG. 11 shows a flowchart for fabricating a smart panel, according to an example embodiment of the present invention.

FIG. 12 shows a smart panel fabrication system, according to an example embodiment of the present invention.

FIG. 13 shows example layer fabricating processes that may be performed in the flowchart of FIG. 1, according to embodiments of the present invention.

FIG. 14 shows a block diagram of a layer fabricator, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### EXAMPLE EMBODIMENTS

The example embodiments described herein are provided for illustrative purposes, and are not limiting. Further structural and operational embodiments, including modifications/alterations, will become apparent to persons skilled in the relevant art(s) from the teachings herein.

Methods, systems, and apparatuses are provided herein for a “smart” panel that may be self-contained, includes one or more functions, and may be modular in construction. In embodiments, the smart panel is assembled to be lightweight, while being stiff or flexible (as desired for a particular application), strong, and tough. The smart panel may include one or more functional elements to enable one or more functions, such as a computing/decision-making function, power generation, power storage, wireless communications capability, memory, one or more sensor functions, display capability for graphics/video, programmatically changing a color of the panel, and/or further functions. Furthermore, a smart panel may be configured to modify itself according to environmental conditions. For instance, a smart panel may be configured to become more stiff/harder or to become more flexible/softer based on sensor readings (e.g., sensing an impact to the smart panel may cause the smart panel to stiffen).

In an embodiment, the smart panel is a multilayered panel, assembled from one or more materials. The materials may be optionally enhanced with micro-scale and/or nano-scale technologies, components, and/or materials. As used herein, a nanoscale material or “nanomaterial” is a structure having at least one region or characteristic dimension with a dimension less than 1000 nm. Examples of nanomaterials, including NEMS (nanoelectromechanical systems) devices and NST (nanosystems technology) devices, are described throughout this document. As used herein, a microscale material or device is a structure having at least one region or characteristic dimension with a dimension in the range of 1 micrometer (μm) to 1000 μm. Examples of microscale materials and devices, including MEMS (microelectromechanical systems) devices and MST (microsystems technology) devices, are described throughout this document.

For example, a panel may be modularly formed by combining multiple layers of one or more materials. A layer of a panel may be formed completely of a single material (i.e., a homogeneous layer), such as a polymer material. Alternatively, a layer may be formed of a first material combined with one or more further materials (e.g., a heterogeneous layer). For example, the material of a layer may be enhanced with one or more nanomaterials. Nanomaterials/components such as nanowires, nanotubes, nanorods, nanoparticles, nanosensors, etc., may be used to enhance the first material of a layer, such as to strengthen the material, to harden the material, or to otherwise modify properties of the layer. The nanomaterials may be organic or inorganic materials. Micro-scale materials/components may additionally or alternatively be used in layers. The micro-scale and/or nano-scale components can vary in size, concentration, orientation, make-up (type), and mixture (multiple types of components in one system), depending on the particular application. Further, materials/components may be either distributed through the material and impregnated in a matrix, or may be discrete elements embedded in the material. In another embodiment, nanomaterials, such as nanoparticles, may be sprayed (optionally with a matrix) or deposited onto a layer. Such materials/components may be configured as functional elements configured to provide functionality to the panel. Examples of such functional elements are described in detail below.

The introduction of nanomaterials into smart panel embodiments can provide numerous benefits. Many nanomaterials have beneficial properties, including strength, stiffness, and hardness. Carbon nanotubes are one of the strongest and stiffest materials known in terms of tensile strength and elastic modulus. A single-wall carbon nanotube is a sheet of graphite (graphene) that is one atom thick, and is rolled in a cylinder with diameter of the order of a nanometer. A carbon nanotube may have a length-to-diameter ratio that exceeds 10,000. Multi-walled carbon nanotubes have been tested to have a tensile strength in the order of 63 GPa, which is much greater than that for high-carbon steel, having a tensile strength of approximately 1.2 GPa. Because carbon nanotubes have a low density for a solid (1.3-1.4 g/cm³), the specific strength of carbon nanotubes (e.g., 48,462 kN·m/kg) is extremely high, compared to that for high-carbon steel (e.g., 154 kN·m/kg). Furthermore, polymerized single walled nanotubes are comparable to diamond in terms of hardness, but are less brittle. Thus, in applications requiring durable materials such as ballistic armor, incorporating nanomaterials in layers of smart panels can provide benefits in strength, stiffness, and hardness, among other benefits. The concentration and types of nanomaterials formed in a layer can be selected as desired for a particular application.

In an embodiment, a layer may be formed as a planar sheet of a material. In another embodiment, a layer may be formed from, or may include woven fibers and/or ribbons of material. In an embodiment, a layer may be a “foam” layer or may include a foam-based material. For example, a foam layer may be formed by applying a suitable material (e.g., a liquid or gel such as a polyurethane) between two solid layers of material (e.g., a polymer material), or into a mold, and causing the material to foam and harden/cure. For example, the material may be a combination of two or more materials that cure when mixed together. The material of the foam layer may have further materials (e.g., nano-materials, functional components, fibers, ribbons, woven fibers, woven ribbons, etc.) dispersed within the foam layer prior to hardening, to provide the benefits of the further materials to the foam layer.

The panels may be modularly configured in any way, by combining layers as desirable for a particular application. For instance, layers may be stacked to form a panel. Any combination of one or more woven, one or more non-woven layers, and one or more foam layers may be stacked to form a panel. The panel may be shaped (e.g., to include one or more bends, curves, etc.) for a particular application. For instance, in an embodiment, the layers of the panel may be shaped prior to being attached together to form the panel. In another embodiment, the panel may be shaped during the process of attaching the layers together. For instance, the layers may be placed in a mold in a manner that the layers conform to a predetermined shape of the mold, and an adhesive material between the layers may be cured/dried to attach the layers together in the predetermined shape. In another embodiment, the panel may be shaped after the layers are attached together to form the panel. For instance, a formed panel may be bent into a desired shape, may be cut into multiple pieces that may be reassembled (e.g., using any of nails, screws, bolts, an adhesive material, etc.) into a desired shape or structure (e.g., a container, body armor, etc.), etc. For example, a panel may be formed by a plurality of layers joined together during a monolithic process, where a foam material is formed between layers to join them together. Such a process may be used to form a panel prior to shaping of the panel, or may be performed in a mold chamber so that the panel is formed in the shape predetermined by the mold chamber.

One or more of the layers in a stack may include a material that is configured to be responsive to an external and/or an internal stimulus. The response mechanism may be an electrical response mechanism, a mechanical response mechanism, a chemical response mechanism, a biological response mechanism, and/or further response mechanism. In embodiments, the material may or may not be configured to communicate external to the material. For example, the material may be configured to communicate a response to a stimulus. For instance, the material may include a sensor configured to monitor a gas (e.g., carbon monoxide), to monitor temperature, or to monitor other stimulus. If the sensor detects a sufficiently high level of the gas, a sufficiently high temperature, etc., an indication of the detected stimulus may be transmitted from the material. If the detected level of gas, temperature, or other stimulus is not sufficiently high, an indication of the stimulus may not be transmitted from the material. In either case, the indication of the stimulus may or may not be transmitted from the material regardless of whether the material otherwise responds to the stimulus.

Example smart panel embodiments, and processes and systems for assembling the same, are described in the following subsections.

### EXAMPLE SMART PANEL EMBODIMENTS

Example embodiments for smart panels are described in this section. Such example embodiments are provided for purposes of illustrations, and are not intended to be limiting. In embodiments, smart panels may include any number of layers, any combination of types of layers, and any number and type of functional elements that are included in any number of layers. Further structural and operational embodiments, including modifications/alterations, will become apparent to persons skilled in the relevant art(s) from the teachings herein.

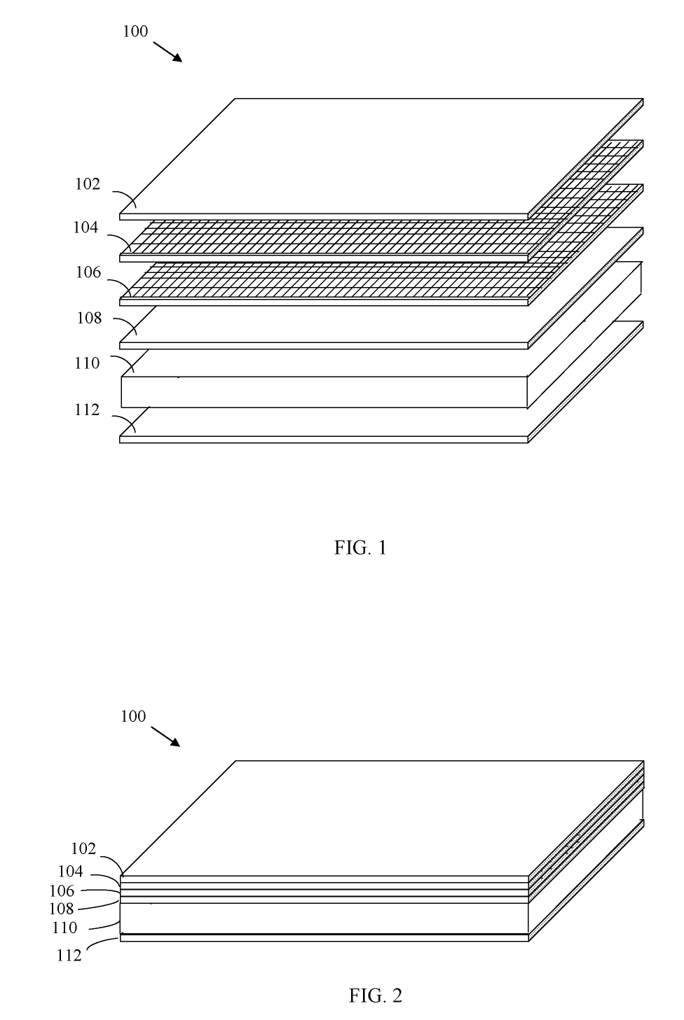

For example, FIG. 1 shows a perspective exploded view of a panel 100, according to an embodiment of the present invention. FIG. 2 shows a perspective side view of panel 100, in non-exploded form. As shown in FIGS. 1 and 2, panel 100 includes a first layer 102, a second layer 104, a third layer 106, a fourth layer 108, a fifth layer 110, and a sixth layer 112. In FIG. 2, first layer 102 is attached to second layer 104, second layer 104 is attached to third layer 106, third layer 106 is attached to fourth layer 108, fourth layer 108 is attached to fifth layer 110, and fifth layer 110 is attached to sixth layer 112 to form panel 100 as a stack of layers.

As shown in FIG. 1, second and third layers 104 and 106 are woven layers of material. Layers 104 and 106 may have any thickness and area, as desired for a particular application. As shown in FIG. 1, layers 104 and 106 may include a mesh material (e.g., two or more sets of fibers having distinct directions that are woven together). For example, as shown in FIG. 1, layers 104 and 106 include a first set of fibers aligned in a first direction that are woven with a second set of fibers aligned perpendicularly (e.g., 90 degrees) to the first direction. In embodiments, the first and second sets of fibers may have any relative alignment in a layer, including being aligned 90 degrees, 45 degrees, or other angle relative to each other. Layers that include a mesh may also include further orientations of fibers, random or otherwise, which may have different lengths relative to each other (e.g., substantially continuous, chopped, etc.). An example of such a layer is a fiberglass matte. Layers 104 and 106 may be weaves of fibers, weaves of woven fibers (a “yarn”), weaves of ribbons, or weaves of further configurations of material.

For example, in an embodiment, layers 104 and 106 may be weaves of polypropylene ribbons, and each of layers 104 and 106 may have a thickness in the range of 0.005-0.006 inches (e.g., 0.132 mm) and a weight of approximately 0.02 lbs/sq-ft (0.11 Kg/sq-meter). Polypropylene may be formed into ribbons using an extrusion process, and the ribbons may be weaved together to form the fabric of each of layers 104 and 106. In an embodiment, nanomaterials (e.g., multi-walled carbon nanotubes) may be introduced into the polymer (e.g., polypropylene) resin before performing the extrusion. For example, layer 104 and/or layer 106 may include a plurality of fiberglass infused polyester tubes having a 0.25 inch inner diameter and a 0.5 inch outer diameter. Persons skilled in the relevant arts would be able to implement tubes having various sizes, including various cross-sectional dimensions, various materials, and various orientations and positions within a stack.

In an alternative embodiment, layers 104 and 106 (and/or one or more other layers in panel 100) may include fibers or rods arranged in a single substantially uniform direction (e.g., being parallel/unidirectional). The fibers/rods may alternatively be oriented in a plurality of directions to accommodate loadings to panel 100 from multiple directions. The fibers may be individual fibers or woven fibers. In embodiments, the rods may be solid or hollow. Example embodiments for layers that include rods are described in further detail below. In a still further embodiment, layers 104 and 106 (and/or one or more other layers in panel 100) may include fibers having random orientations.

First, fourth, and sixth layers 102, 108, and 112 are homogeneous planar layers of material. Layers 102, 108, and 112 may be formed in a variety of ways, including by a molding process, an extruding process, being cut from a larger sheet of material, or by other process of forming, as would be known to persons skilled in the relevant art(s). Layers 102, 108, and 112 may be made of a variety of materials, such as a thin film, monolithic material. For example, layers 102, 108, and 112 may be made of a polymer, such as polyurethane, polyester, acrylic, phenolic, epoxy, elastomerics, polyolefins, polypropylene, polyethylene, vinyl ester, etc. In one embodiment, layers 102, 108, and 112 may be made of a homogeneous material. For example, in an embodiment, each of layers 102, 108, and 112 may be a polyurethane (PU) thin film, having a thickness in the range of 0.010-0.015 inches. In another embodiment, layers 102, 108, and 112 may include a first material (e.g., a polymer) that has one or more further materials included therein, such as one or more microscale materials and/or nanomaterials. A layer that does not include such microscale materials and nanomaterials may be referred to as a “neat” layer.

Fifth layer 110 is a foam layer. Fifth layer 110 may be formed in various ways, such as by applying a suitable material (e.g., liquid or gel such as an epoxy) between two solid layers of material (e.g., fourth and sixth layers 108 and 112 in FIGS. 1 and 2), and causing the material to cure (e.g., into a stiff or flexible form). Alternatively, fifth layer 110 may be formed (e.g., in a mold) and subsequently positioned between fourth and sixth layers 108 and 112. In an embodiment, the material of fifth layer 110 may be a combination of two or more materials that cure when mixed together. The material of layer 110 may have further materials (e.g., nano-materials, functional components, etc.) dispersed within prior to curing, to provide the benefits of the further materials to fifth layer 110.

Note that the particular arrangement of layers, the number of layers, and combination of different types of layers for panel 100 in FIGS. 1 and 2 are provided for purposes of illustration, and are not intended to be limiting. In embodiments, any arrangement of layers, number of layers, and combination of layers may be provided in a panel. In embodiments, the number of each type of layer in a panel, and a ratio of layer types (e.g., solid, woven, foam, etc.) can have any value. Layers may be attached (e.g., laminated, glued, etc.) to each other in panel 100 in a variety of ways. For example, an adhesive material, such as a glue, a resin, a foam material, a thin film adhesive, etc., may be applied to surfaces of layers to attach adjacent layers together. The adhesive material may be applied in any form, including as a gel, liquid, or solid, an in any manner, including by pouring, flowing, spraying, rolling on, etc. In an example, pressure thermoforming techniques, such as autoclave or a compression molding process, may be used to compress/heat layers into panel 100. For instance, one or more thin sheets of thermoplastic adhesive may be interspersed between adjacent layers of a stack. The thin sheets of thermoplastic adhesive themselves may be homogeneous materials or heterogeneous materials (e.g., have one or more nanomaterials and/or functional materials included therein). The stack may be heated, thereby activating the thermoplastic adhesive to adhere the layers of the stack together. In another embodiment, a foam layer, as described above, may be formed between two other layers. The foam layer may operate as an adhesive material to attach together the two layers (in addition to providing any further features that may be provided by the foam layer).

Note that in a further embodiment, panel 100 may include one or more layers of further materials. For example, panel 100 may include one or more layers of fabric made from another synthetic fiber such as Kevlar, additional types of nanoparticles, etc., that are interspersed throughout panel 100. In another embodiment, panel 100 may include one or more layers of recyclable materials. For example, the properties of an extruded polypropylene (or other material) ribbon may be enhanced by recycling and then re-extruding the polypropylene into ribbon form a second time or even further times.

Each layer may be selected/tuned to a degree of precision based on the requirements of a particular application, such as impact resistance, stiffness, melt-point, flammability, chemical resistance, electrical conductivity, density, and/or other requirements. Such tuning can be performed in a number of ways. For example, tuning can be performed by selecting the material for the layer, selecting dimensions of the layer (e.g., thickness, length, width), selecting whether the layer is woven, non-woven, or foam, if the layer is woven, selecting whether fibers, matte, yarn, and/or ribbon is woven to form the layer, selecting whether to add nanomaterials to the layer, selecting the type of and concentration of nanomaterials added to the layer (if added), and/or by performing other selection criteria described elsewhere herein or otherwise known.

In an embodiment, a panel may be manufactured to be any weight, including lightweight, medium weight, or heavyweight, depending on factors such as materials used in layers of the panel, thicknesses of the layers, a number of layers, etc. A panel may be manufactured of any thickness, including thick, medium thickness, and/or thin. For example, in one embodiment, a panel can be 0.5 pounds per square foot at ¼″ thick. In an embodiment, a panel may be stiff or flexible.

Embodiments enable a modularly-constructed panel/system, constructed from modular/interchangeable components. This is a system of building blocks, fully integrated to create a self-contained system. Panels may be modularly combined as building blocks to create a variety of form factors. Furthermore, panels may be manufactured that are fully integrated and self-contained. For example, panels requiring power may include power generation and storage capability. Micro- and/or nanotechnology based technologies can be integrated with traditional manufacturing techniques as desired based on the particular application. Micro- and nanotechnologies encompass any technologies where the performance criterion is met by engineering on and having knowledge of the same size scale as the phenomena of interest.

One example panel configuration includes multiple materials and components in a layered system. A polymer “skin” layer is provided on both outer sides of the panel configuration. A secondary material layer of the panel configuration may be a material such as a foam material core, which may be reinforced with a weave of fibers, random fibers, rods, and/or further materials distributed throughout the layer. Multiple layers can be used to provide a desired strength/thickness. The panel configuration includes one or more sensors and/or other components distributed throughout the panel (e.g., in the skin layers and/or the core layer(s)). In an embodiment, the sensors may also be built into the matte/weave/fibers/skins. Each layer/material may be enhanced with nanoparticles.

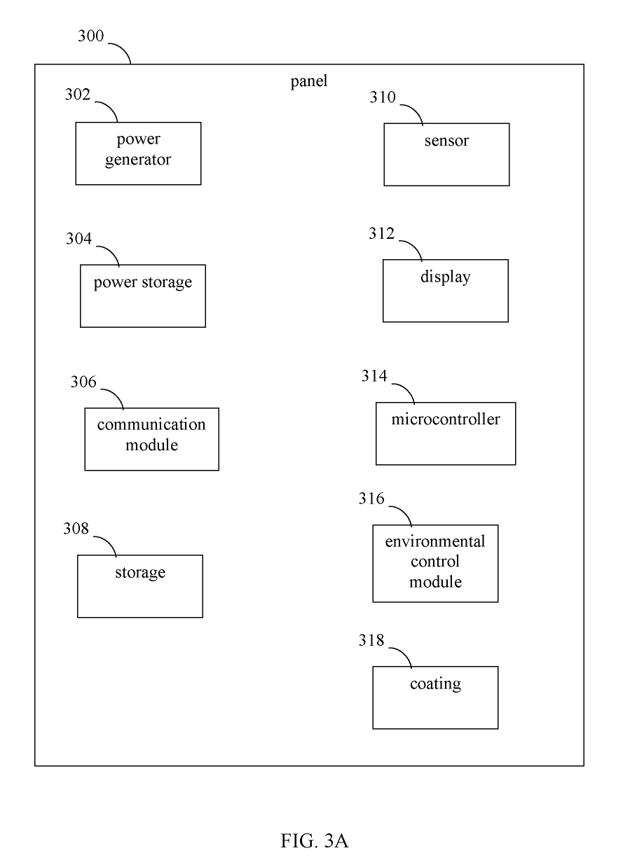

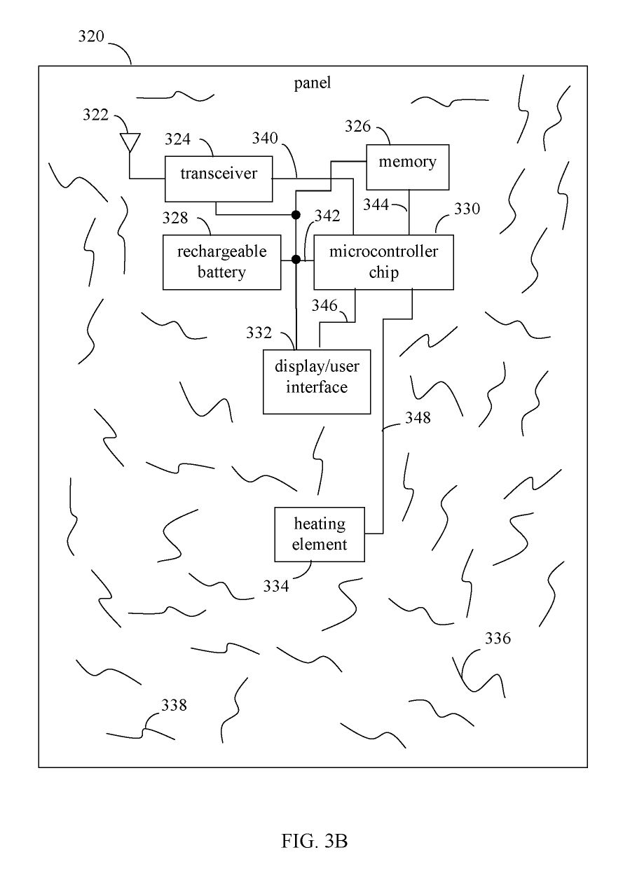

In example embodiments, panels of the present invention may include one or more of the elements shown in FIG. 3A. FIG. 3A shows a panel 300 that includes a power generator 302, power storage 304, a communication module 306, a data storage 308, a sensor 310, a display 312, a microcontroller 314, an environmental control module 316, and a coating 318. Each of these elements may be present in one or more layers of a panel, such as panel 100 shown in FIGS. 1 and 2. For example, arrays of any of these elements may be present in one or more layers of a panel. Embodiments for each of these elements, which may be present in panel embodiments, are described as follows. Note that the elements shown in FIG. 3A may be distributed or discrete. The elements are shown in FIG. 3A as discrete for purposes of illustration.

In embodiments, panel 300 may include a communication medium, wired and/or wireless, for elements of panel 300 to communicate with each other and/or for communication within elements (e.g., for elements that include an array of sub-elements). For example, communication module 306, as further described below, may be used for communications within panel 300, as well as communications with entities external to panel 300. In an embodiment, a layer of panel 300 may be a flexible (or non-flexible) trace layer providing a network of electrical connections for panel 300. Wires, wire ribbons, nanowires, and/or further types of electrically conducting (including semi-conducting), materials may be used for physical electrical connections within panel 300. For example, in an embodiment, a particular layer of panel 300 may be configured as an interconnection layer for panel 300. The interconnection layer may include electrical wiring or other electrical connections of any form, to distribute power to elements of panel 300 and/or to enable elements of panel 300 to communicate with each other.

In an embodiment, a panel may be configured to generate power. For example, power generator 302 may include one or more power generation mechanisms, such as a solar power generator (e.g., solar cells), mechanical motion power generators (e.g., piezoelectric membranes, piezoelectric nanorods that generate power due to vibration, nanowires that generate electricity due to motion/vibration, etc.), resistive power generators, and/or further power generation/energy harvesting mechanisms to generator power for panel 300. For example, an outer layer of panel 300 may be an active photovoltaic layer. A single power generation mechanism may be present in panel 300, or multiple power generation mechanisms may be present in panel 300. For example, an array of power generation elements may be distributed throughout panel 300 (e.g., within a material of one or more layers of panel 300, and/or on a surface of one or more layers of panel 300), or otherwise positioned in panel 300. For example, in an embodiment, power generator 302 may be a MEMS power harvesting integrated circuit die or chip. An array of such dies/chips may be present in panel 300. In an embodiment, a material of one or more layers of panel 300 may be configured to generate power. In another embodiment, one or more discrete power generator elements may be included in one or more layers of panel 300.

In an embodiment, a panel may be configured to store power/energy, such as through the incorporation of one or more batteries, and/or other form of distributed power storage mechanism or element. For example, power storage 304 may include one or more batteries and/or other types of power storage mechanisms/elements. For instance, in an embodiment, a panel may include a pair of electrically conductive (e.g., metal) layers that sandwich a dielectric layer to form a capacitor for storing power. Example types of batteries include thin film lithium ion batteries, distributed chip scale capacitors, conventional batteries, etc. A single power storage mechanism/element may be present in panel 300, or multiple power storage mechanisms/elements may be present in panel 300. For example, an array of power storage elements may be distributed throughout panel 300, or otherwise positioned in panel 300.

In an embodiment, a panel may be configured to communicate wirelessly with other devices that are external or internal to the panel, including receiving information from, and transmitting information to such external and/or internal devices. For example, panel 300 may include communication module 306. Communication module 306 may include a transmitter and a receiver (or transceiver), and one or more antennas. Communications module 306 is configured to enable panel 300 to communicate with other communication modules of panel 300 and/or with one or more remote entities. For example, communications module 306 may be configured to communicate with a structure with which panel 300 is associated, such as a controller, GPS system, or other component of a vehicle with which panel 300 is associated. Panel 300 may be configured to communicate with a remote computer system, including a mobile device (e.g., Palm Pilot, personal digital assistant (PDA, notebook computer, etc.), a centralized entity, etc.

For example, communications module 300 may be configured to communicate with a communications network in a wired or wireless fashion, including a personal area network (PAN) (e.g., a BLUETOOTH network), a local area network (e.g., a wireless LAN, such as an IEEE 802.11 network), and/or a wide area network (WAN) such as the Internet. Thus, communication module 306 may include a BLUETOOTH chip, WLAN chip, etc., conventionally used in devices, and/or other communication enabling hardware/software/firmware. Communication module 306 may communicate according to radio frequencies (RF), infrared (IR) frequencies, etc. Communication module 306 may be configured to transmit data from panel 300, such as data captured by sensor 310, information from microcontroller 314, and/or further data. Furthermore, communication module 306 may be configured to receive data for panel 300, such as instructions for panel 300 (e.g., for microcontroller 314), data for storage in data storage 308, image data for display by display 312, and/or further data.

A single communication module 306 may be present in panel 300, or multiple communication modules 306 may be present in panel 300. For example, an array of communication modules 306 may be distributed throughout panel 300, or otherwise positioned in panel 300.

In an embodiment, a panel may be configured to store information. For example, panel 300 may include data storage 308. Data storage 308 is used to store information/data for panel 300. For example, captured sensor data, manifest data, etc., may be stored in data storage 308. Images may be stored in data storage 308, such as advertisement images, etc., that may be displayed by display 312, as further described below.

Data storage 308 can be any type of storage medium, including memory circuits (e.g., a RAM, ROM, EEPROM, or FLASH memory chip), a hard disk/drive, optical disk/drive (e.g., CDROM, DVD, etc), etc., and any combination thereof. Data storage 308 can be built-in storage of panel 300, and/or can be additional storage installed (removable or non-removable) in panel 300. A single storage element may be present in panel 300, or multiple storage elements may be present in panel 300. For example, an array of storage elements may be distributed throughout panel 300, or otherwise positioned in panel 300.

In an embodiment, a panel may incorporate one or more sensors. For example, panel 300 may include sensor 310. Sensor 310 can be any type of sensor, including a microscale sensor (e.g., a microelectromechanical sensor (MEMS)) or a nanoscale sensor. For example, sensor 310 can be an environmental sensor that detects an environmental attribute with regard to a locality associated with panel 300, such as a gas (e.g., carbon dioxide, carbon monoxide, methane, etc.), a chemical, weather, temperature, pressure, light, wind, vibration, etc. Sensor 310 can be a sensor desired to be used in homeland security applications. For instance, sensor 310 may be configured to sense bomb making materials, toxic substances, nuclear materials/radiation, chemical warfare agents, etc. Sensor 310 can be configured to sense motion, such as being an accelerometer, a gyro, or other motion sensor. For example, sensor 310 may be configured to detect tilt, such as the tilt of a payload carried by a truck or other structure associated with panel 300. Sensor 310 can be a light sensor, a sound sensor (e.g., a microphone), or any other sensor type. A single sensor 310 may be present in panel 300, or multiple sensors 310 may be present in panel 300. For example, an array of sensors 310 may be distributed throughout panel 300, or otherwise positioned in panel 300. Sensor(s) 310 may be positioned anywhere in panel 300, including in a coating 318 of panel 300 and/or in a layer of panel 300 (e.g., embedded in a foam layer, etc.). In an embodiment, one or more of sensor(s) 310 may be upgradable and/or changeable (e.g., may be changed if a sensor ceases to function correctly).

In an embodiment, a panel may include one or more displays to display text and/or graphics, such as video, and/or to enable panel 300 to change colors programmatically. For instance, panel 300 may include display 312. Display 312 may be any type of display, including an LCD (liquid crystal display) panel or other display mechanism. In another embodiment, display 312 is a micro- or nano-enabled display. For example, display 312 may include an array of mirrors, similar in scale and operation to a digital light processing (DLP) display. Alternatively, display 312 may include an array of nanomaterials in a layer (or multiple layers) of panel 300 configured to function as a display. Such a display may be present over any portion, including all, of a surface of panel 300, including an entire surface of the structure with which panel 300 is associated. Such a panel 300 (or combination of panels 300) may be configured to display a color as the color of the structure (e.g., a blue truck, a red car, etc.), one or more static images (e.g., advertising or marketing images), one or more motion images (e.g., video, such as an advertising video), etc. A single display 312 may be present in panel 300, or multiple display devices 312 may be present in panel 300. For example, an array of displays 312 may be distributed throughout panel 300, or otherwise positioned in panel 300. For instance, display 312 may be a device or a layer (e.g., a complete or partial layer) in panel 300. In one example embodiment, display 312 may be configured to display one or more pre-programmed images and/or videos. In another embodiment, display 312 may display images and/or video according to instructions received from microcontroller 314. In an embodiment, particular images and/or video may be displayed by display 312 depending upon stimuli received/detected by sensor 310.

In an embodiment, a panel may include temperature/environmental control functionality. For example, in one embodiment, panel 300 may include environmental control module 316. Environmental control module 316 may include a heat generator (e.g., including one or more heating elements) and/or a cooling device (e.g., one or more heat removing/transferring elements) and/or may include one or more temperature sensors (and/or may receive temperature information from sensor 310). For example, environmental control module 316 may include a thermoelectric cooler for cooling purposes. Panel 300 may include materials (e.g., metals, etc.) configured to transfer/spread heat.

Environmental control module 316 may be used to regulate the temperature of panel 300. For example, environmental control module 316 may regulate a temperature of panel 300 to regulate a temperature of a structure that panel 300 is incorporated into. Environmental control module 316 may regulate a temperature of panel 300 to minimize variability in operation of sensor 310. Environmental control module 316 may regulate a temperature of panel 300 for additional reasons. A single environmental control module 316 may be present in panel 300, or multiple environmental control modules 316 may be present in panel 300. For example, an array of environmental control modules 316 may be distributed throughout panel 300, or otherwise positioned in panel 300.

In an embodiment, a panel may be controlled by a user and/or may be centrally controlled. For example, in one embodiment, panel 300 may include a user interface, such as a keypad, touch pad, a touch screen (e.g., display 312), a roller ball, a stick, a click wheel, and/or voice recognition technology for a user to control and/or otherwise interact with panel 300. In an embodiment, panel 300 may include microcontroller 314. Microcontroller 314 may be any type of microcontroller/processor, including hardware, software, and/or firmware, including in silicon, nanowire, and/or any other form. Microcontroller 314 may be present to perform a control function for panel 300, including coordinating/instructing operation of display 312, accessing communication module 306 to receive and/or transmit communications, to access data storage 308, communicating with sensor 310, controlling/monitoring environmental control module 318, etc. A single microcontroller 314 may be present in panel 300, or multiple microcontrollers 314 may be present in panel 300. For example, an array of microcontrollers 314 may be distributed throughout panel 300, or otherwise positioned in panel 300.

Panel 300 may include one or more layers, such as one or more outer layers (e.g., top and bottom layers) configured to provide environmental protection for panel 300. For example, the one or more protective layers may be made from a harder and/or more durable material (e.g., a dense polymer, a metal, etc.) and/or may incorporate nanomaterials and/or other particles (e.g., metal particles) that increase a durability and/or hardness of the one or more layers. The one or more protective layers may provide protection against weather (e.g., rain, sleet, snow, extreme cold, extreme heat), against impacts (e.g., from vehicles, from projectiles such as bullets, etc.), against explosions, and/or against further external threats and/or internal threats or sources of damage. For example, panel 300 may form a container, or may be formed around the outer surface of a container, that is configured to contain an explosive material. Panel 300 may be configured to damp the explosive force of the container if the explosive material inside the container explodes. Furthermore, the protective layers may include one or more functional elements, as desired for a particular application. For example, a protection layer may include solar energy collection elements (e.g., power generators 302).

In embodiments, a panel may include one or more of a variety of types of coatings 318, such as polymers, paints, ceramics, metals, etc. For example, in an embodiment, coating 318 of panel 300 is a skin gel coat, which may be clear or opaque, and may be applied in any manner, such as by spraying, painting, depositing, etc. Coating 318 may be a color-changing paint, for example. For example, a color of coating 318 may be configured to change according to environmental attributes (e.g., temperature), or according to a control signal provided by microcontroller 314.

The elements of panel 300 shown in FIG. 3A may be distributed homogeneously through the material of the layer(s) of panel 300, or may be formed by discrete elements impregnated within in the material. In further embodiments, panel 300 may include additional and/or alternative elements to those shown in FIG. 3A, such as signal conditioning elements, a radio frequency identification (RFID) reader and/or a RFID tag, etc.

FIG. 3B shows an example panel 320 that includes functional elements, according to an example embodiment of the present invention. As shown in the example of FIG. 3B, panel 320 includes an antenna 322, a transceiver 324, a memory 326, a rechargeable battery 328, a microcontroller chip 330, a display/user interface 332, a heating element 334, a sensor 336, and a power generator/storage element 338. Panel 320 is an example of panel 300 shown in FIG. 3A, and is provided for purposes of illustration, and is not intended to be limiting. In FIG. 3A, functional elements were illustrated as discrete elements. In FIG. 3B, some functional elements are illustrated in a distributed manner, such as sensors 336 and power generator/storage elements 338. In embodiments of panel 320, any one or more of the functional elements shown in FIG. 3B may be present, with additional and/or alternative functional elements. Furthermore, the functional elements 320 may be interconnected as shown in FIG. 3B or in other ways, as would be known to persons skilled in the relevant art(s) in view of the teachings herein. The elements of panel 320 shown in FIG. 3B are described as follows.

Microcontroller chip 330 shown in FIG. 3B is an example of microcontroller 314 shown in FIG. 3A. In the example of FIG. 3B, microcontroller chip 330 is a processor chip (e.g., silicon or gallium arsenide) and may optionally be encapsulated in an integrated circuit chip package. Other functional elements of panel 320 may interface with signals of microcontroller chip 330 at corresponding I/O terminals of microcontroller chip 330 using corresponding wires (e.g., bond wires, nanowires, etc.) or other connection mechanisms. The I/O terminals may be pads, pins, solder balls, or any other type of chip terminal or interface. Microcontroller chip 330 provides control functionality for panel 320. Examples of such control functionality are described as follows.

As shown in FIG. 3B, transceiver 324 is coupled to antenna 322. Antenna 322 may be any type of antenna, including a dipole antenna, a Yagi-Uda antenna, or other type of antenna. Transceiver 324 shown in FIG. 3B is an example of communication module 306 shown in FIG. 3A. Transceiver 324 is configured to transmit communication signals from panel 320 and to receive communication signals for panel 320. For example, microcontroller chip 330 may transmit data to transceiver 324 over a communication link 340 (e.g., one or more wires, a parallel signal bus, etc.) for transmission from panel 320. Transceiver 324 may be configured to up-convert and/or modulate the data onto a communication signal transmitted by antenna 322. Furthermore, transceiver 324 may down-convert and/or demodulate a communication signal received by antenna 322 into data, which is provided by transceiver 324 to microcontroller chip 330 over communication link 340.

Power generator/storage element 338 shown in FIG. 3B is an example of power generator 302 shown in FIG. 3A. Power generator/storage element 338 is configured to generate and/or store power/energy that may be used to power functional elements of panel 320, such as transceiver 324, memory 326, microcontroller chip 330, and display/user interface 332. Panel 320 may include a plurality of power generator/storage elements 338, including hundreds, thousands, millions or even greater numbers of power generator/storage elements 338. Such power generator/storage elements 338 may have various forms, including in the form of nanomaterials, microscale materials, etc. For instance, in the example of FIG. 3B, a power generator/storage element 338 may be a piezoelectric membrane or a nanowire configured to generate electricity due to motion/vibration of panel 320.

Rechargeable battery 328 shown in FIG. 3B is an example of power storage 304 shown in FIG. 3A. In the example of FIG. 3B, rechargeable battery 328 may be present to receive power/energy from power generator/storage elements 338 for storage, and to provide power to functional elements of panel 320. For example, rechargeable battery 328 may include one or more lithium, nickel-cadmium, or other type of rechargeable battery material, including nano-enabled power storage materials. Rechargeable battery 328 may be coupled to power generator/storage elements 338 to receive generated power for storage. Rechargeable battery 328 may be coupled to power generator/storage elements 338 in any manner, including by wires (e.g., nanowires), one or more diodes, etc. For instance, FIG. 3B shows a power bus 342 (e.g., one or more wires) used to couple power from rechargeable battery 328 to transceiver 324, memory 326, microcontroller chip 330, and display/user interface 332.

Sensor 336 shown in FIG. 3B is an example of sensor 310 shown in FIG. 3A. In the example of FIG. 3B, sensor 336 may be present to provide any desired type of sensor functionality, including those sensor functions described above or sensor functions that are otherwise known. Panel 320 may include a plurality of sensors 336, including hundreds, thousands, millions or even greater numbers of sensors 336. For instance, sensor 336 may be a microscale sensor (e.g., a microelectromechanical sensor (MEMS)) or a nanoscale sensor. Sensor 336 may be coupled to microcontroller chip 330 to provide sensor data to microcontroller chip 330 in any manner, including by one or more wires (e.g., nanowires), etc.

Panel 320 may be configured to modify itself according to environmental conditions. For instance, panel 320 may be configured to become more stiff/harder or to become more flexible/softer based on readings by sensor 336. For example, sensor 336 may be a pressure or displacement sensor. If sensor 336 senses an impact to panel 320, sensor 336 may transmit an indication of the impact to microcontroller 330, which may instruct a material of panel 320 (e.g., an electrically deformable material, such as an electrically deformable polymer, nanomaterial, etc.) to stiffen to enable panel 320 to provide additional protection to a wearer (e.g., a person wearing panel 320 as armor) or other entity. Sensor 336 may be configured to enable panel 320 to modify itself in further ways, as would be known to persons skilled in the relevant art(s) in view of the teachings herein.

Memory 326 shown in FIG. 3B is an example of data storage 308 shown in FIG. 3A. For example, memory 326 may be one or more memory chips (e.g., static or dynamic RAM). Microcontroller 330 is coupled to memory 326 by a communication link 344 (e.g., one or more wires, a parallel signal bus, etc.). Microcontroller 330 may store data in data storage 308, such as sensor data (received from sensors 336), image and/or video data (e.g., received from a remote source through transceiver 324), and/or other data (e.g., instructions received from a remote source through transceiver 324). Furthermore, microcontroller 330 may access data stored in data storage 308, such as sensor data (to be provided to transceiver 324 to transmit from panel 320), image and/or video data (to be provided to display/user interface 332 for display), and/or further data (e.g., instructions).

Display/user interface 332 shown in FIG. 3B is an example of display 312 shown in FIG. 3A. Display/user interface 332 is configured to display information, including text, images, and/or video. As shown in FIG. 3B, display/user interface 332 is coupled to microcontroller chip 330 by a communication link 346 (e.g., one or more wires, a parallel signal bus, etc.). Furthermore, display/user interface 332 may provide a touch screen or other interface for a user to access data and/or to provide instructions to microcontroller chip 330. For example, display/user interface 332 may enable a user to request sensor data stored in memory 326 to be displayed.

Heating element 334 shown in FIG. 3B is an example of environmental control module 316 shown in FIG. 3A. As shown in FIG. 3B, heating element 334 is coupled to microcontroller chip 330 by a communication link 348 (e.g., one or more wires, a parallel signal bus, etc.). Heating element 334 may be configured to maintain a relatively constant temperature for panel 320 or to prevent a temperature of panel 320 from becoming too low (e.g., when panel 320 is positioned in a cold environment). For instance, in an embodiment, heating element 334 may be one or more resistive heating elements or other types of heating elements. In an embodiment, one or more of sensors 336 may be configured to measure temperature, and to provide temperature data to microcontroller chip 330. If microcontroller chip 330 determines from the temperature data that the environmental temperature is below a temperature threshold, microcontroller chip 330 may be configured to provide a control signal to heating element 334 over communication link 348 to cause heating element 334 to generate heat. If microcontroller chip 330 determines from the temperature data that the environmental temperature is above a temperature threshold, microcontroller chip 330 may be configured to provide a control signal to heating element 334 over communication link 348 to cause heating element 334 to stop generating heat. Alternatively, heating element 334 may include a built-in sensor configured to monitor environmental temperature and to cause heating element 334 to generate heat if the environmental temperature falls below a temperature threshold.

Note that in an embodiment, heating element 334 may instead by a cooling element configured to cool panel 320. Alternatively, one or more heating elements 334 and one or more cooling elements may both be present in panel 320 as an example of environmental control module 316 shown in FIG. 3A.

The functional elements of panel 320 may be included in any one or more layers of panel 320. For instance, in an embodiment, antenna 322 and display/user interface 332 may be attached to or mounted in an outer layer of panel 320. Antenna 322 may be located in the outer layer to enable high quality signal transmission and reception, and display/user interface 332 may be located in the outer layer to enable user access. Sensors 336 and power generator/storage elements 338 may be included in an outer layer of panel 320 and/or in one or more inner layers of panel 320. Transceiver 324, memory 326, rechargeable battery 328, microcontroller chip 330, and heating element 334 may be included in one or more inner layers of panel 320 (e.g., for their protection). In other embodiments, these functional elements of panel 320 may be configured in other locations.

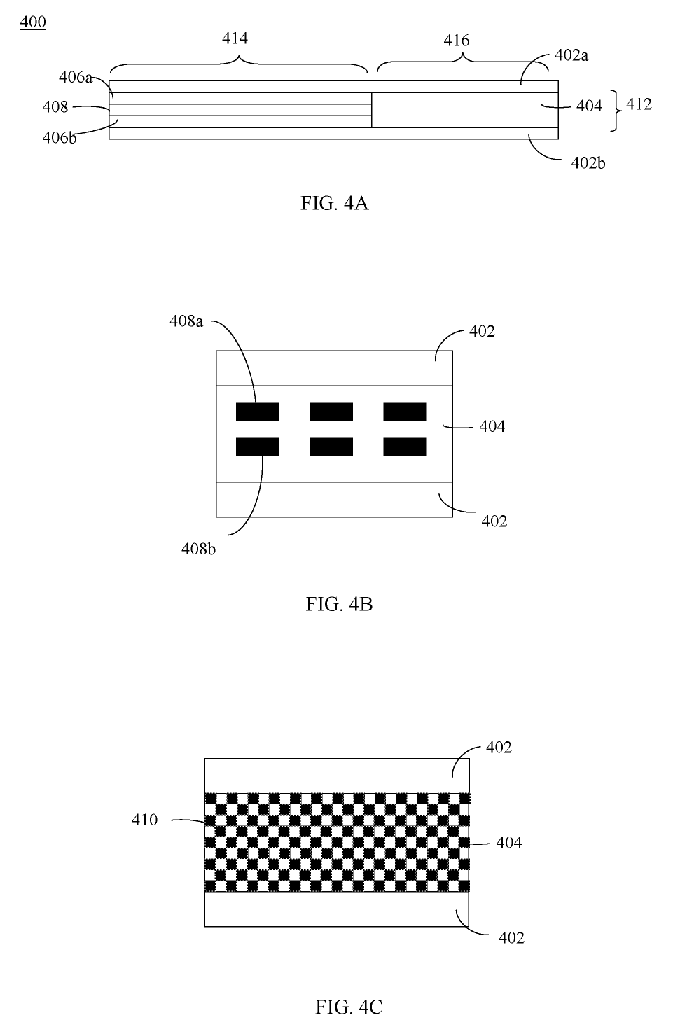

FIG. 4A shows an example panel 400, according to another embodiment of the present invention. Panel 400 includes a first coating layer 402a, a second coating layer 402b, an active layer 404, a first conductive layer 406a, a second conductive layer 406b, and an energy storage layer 408. Active layer 404, first conductive layer 406a, second conductive layer 406b, and energy storage layer 408 are included in a core portion 410 of panel 400. First coating layer 402a is formed on a first surface of a core portion 412 of panel 400. Second coating layer 402b is formed on a second surface of core portion 412 of panel 400. Layers 402a, 402b, 404, 406a, 406b, and 408 may include any of the materials and layer types (e.g., homogeneous, heterogeneous, solid, woven, foam, rods, etc.) described elsewhere herein, and may be attached together in any manner described elsewhere herein or otherwise known.

Core portion 412 of panel 400 has a first portion 414 and a second portion 416. First portion 414 of core portion 412 includes a stack of first conductive layer 406a, energy storage layer 408, and second conductive layer 406b. Second portion 416 of core portion 412 includes active layer 404.

First and second coating layers 402a and 402b provide environmental protection for panel 400. First and second conductive layers 406a and 406b provide power and signal pathways from energy storage layer 408 to active layer 404. Energy storage layer 408 provides a power repository for panel 400. Active layer 404 provides functionality of panel 400. For example, FIGS. 4B and 4C show cross-sectional views of second portion 416 in panel 400, according to example embodiments of the present invention. As shown in FIG. 4B, active layer 404 includes a plurality of functional/active elements 408 (e.g., first and second functional/active elements 408a and 408b) embedded in active layer 404. For example, active elements 408 may be any of the elements/components described elsewhere herein, discrete, distributed, or a combination thereof, such as those shown in panel 300 in FIG. 3A and in panel 320 in FIG. 3B. In the embodiment of FIG. 4C, active layer 404 includes a plurality of functional/active elements 410 distributed throughout a material of active layer 404 to form a homogeneous layer,

In embodiments, multiple layers of materials may be used to form a single functional layer. Functional/active elements 408/410 can include processing elements, sensing elements, communication elements, and/or any other elements described elsewhere herein. More than one type of active element can be used in any single layer.

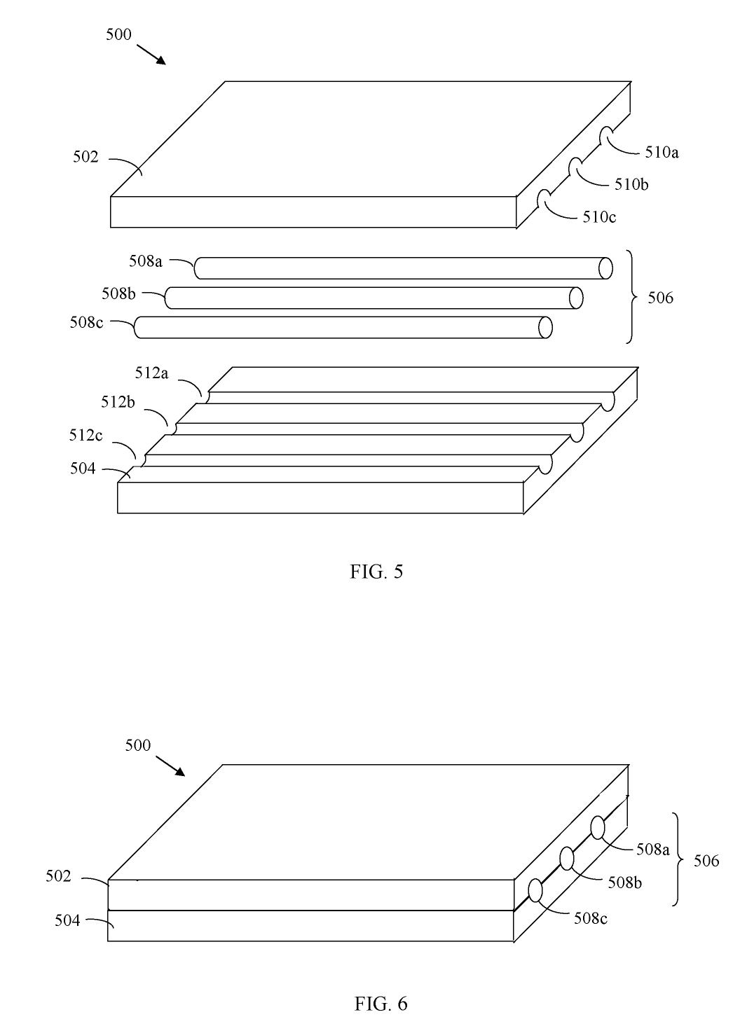

In embodiments, one or more layers of a panel may include rods that provide structural reinforcement to the panel. FIG. 5 shows a perspective exploded view of a panel 500 that includes rods, according to an example embodiment of the present invention. FIG. 6 shows a perspective side view of panel 500, in non-exploded form. As shown in FIGS. 5 and 6, panel 500 includes a first layer 502, a second layer 504, and a third layer 506. First and second layers 502 may each be any layer type described elsewhere herein, including a layer of a homogeneous material, a layer of material that includes micro- and/or nanomaterials, a layer that includes functional elements, a layer that includes a layer that includes fibers, ribbons, and/or woven materials, etc. Third layer 506 is a layer of rods 508, and may also be referred to as a “rod layer.” Any number of rods 508 may be present in layer 506. For instance, in the example of FIGS. 5 and 6, third layer 506 includes first-third rods 508a-508c. Rods 508 have a generally cylindrical shape, having a circular cross-section, although rods 508 may have other shapes, including having rectangular cross-sections. Furthermore, rods 508 may have any length, as desired for a particular application. Third layer 506 is positioned between first and second layers 502 and 504 to form panel 500 as a stack of layers.

Rods 508 can be solid (e.g., as shown in FIGS. 5 and 6) or can be hollow (e.g., can be tubes). Rods 508 can be made of any suitable material, including any polymer mentioned elsewhere herein or otherwise known, a metal (e.g., aluminum, titanium, etc.) or combination of metals/alloy (e.g., steel), a ceramic material, a composite material, fiberglass infused polyester tubes, etc. Rods 508 can be made of layer materials described elsewhere herein, including having fibers, weaves, nanomaterials, and/or functional elements included therein. In the example of FIGS. 5 and 6, rods 508a-508c are shown having a substantially parallel/unidirectional arrangement. Furthermore the rods 508 may be joined to each other using a mechanism (e.g., couplings, clips, ties, adhesive, etc.) that may be apparent to those skilled in the art prior to be being received by the layer fabricator. However, in alternative embodiments, rods 508 in third layer 506 may have other arrangements, including a non-parallel arrangement (e.g., a random arrangement). Rods 508 can have any suitable size, including having diameters in the order of an inch, having nano-scale diameters, or having diameters greater than or between these ranges.

A panel that includes rods 508 may be manufactured in a variety of ways. For instance, as shown in FIGS. 5 and 6, first and second layers 502 and 504 may be formed separately from each other. As shown in FIG. 5, a first set of cylindrical recesses 510 (e.g., recesses 510a-510c) may be formed in a surface of first layer 502, and a second set of cylindrical recesses 512 (e.g., recesses 512a-512c) may be formed in a surface of second layer 504. Recesses 510 and 512 may be formed in any manner, such as by a molding process (e.g., by molds used to form layers 502 and 504), by machining recesses 510 and 512 into layers 502 and 504, by impressing recesses 510 and 512 into layers 502 and 504 (e.g., by heating layers 502 and 504 and subsequently applying pressure), etc. To form panel 500, rods 508 may be positioned between layers 502 and 504, and layers 502 and 504 may be moved into contact with each other, with rods 508 fitting into recesses 510 and 512.

In another embodiment, recesses 510 and 512 may not be pre-formed in first and second layers 502 and 504. To form panel 500, rods 508 may be positioned between layers 502 and 504, and layers 502 and 504 may be moved into contact with each other. By compressing layers 502 and 504 together, rods 508 may form recesses 510 and 512 in layers 502 and 504, respectively.

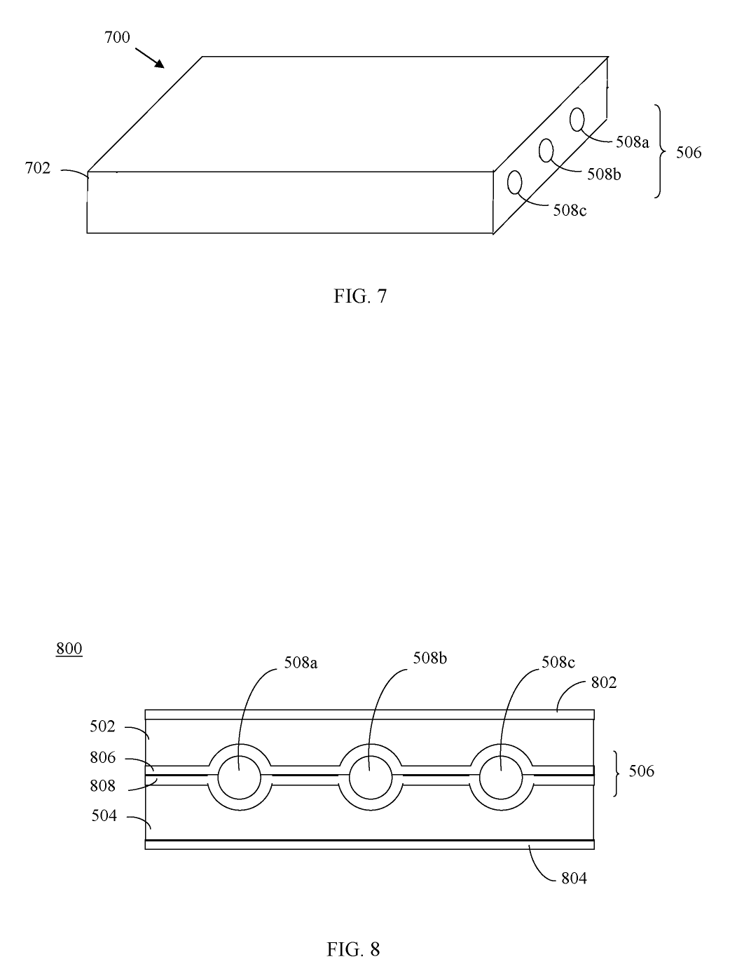

In another embodiment, layers 502 and 504 may instead be formed as a single layer in which rods 508 are positioned. FIG. 7 shows an example of a panel 700 which is formed of a single layer 702 of material that encapsulates rods 508 (e.g., rods 508a-508c). For instance, layer 702 may be formed in any manner described elsewhere herein or otherwise known, and holes may be drilled through layer 702 in which rods 508 may be inserted. Alternatively, rods 508 may be positioned in a mold, and a material may be inserted into the mold to form layer 702 around rods 508. Panels 500 and 700 may be formed in alternative ways, as would be known to persons skilled in the relevant art(s).

Referring back to FIGS. 5 and 6, layers 502, 504, and 506 may be attached together in any manner, including in other ways for attaching layers described elsewhere herein. For instance, FIG. 8 shows a cross-sectional view of a panel 800, formed according to an example embodiment of the present invention. Panel 800 is an example of panel 500 shown in FIGS. 5 and 6. As shown in FIG. 8, panel 800 includes first, second, and third layers 502, 504, and 506. Furthermore, panel 800 includes a first coating layer 802, a second coating layer 804, a first adhesive layer 806, and a second adhesive layer 808. First coating layer 802 is positioned on a first surface of first layer 502 that is opposite a second surface of first layer 502 that is adjacent to third layer 506. Second coating layer 804 is positioned on a first surface of second layer 504 that is opposite a second surface of second layer 504 that is adjacent to third layer 506. First and second coating layers 802 and 804 may each be any type of coating layer described elsewhere herein, including a layer of material (e.g., a polymer) that includes nanomaterials, etc. First and second coating layers 802 and 804 may be applied to first and second layers 502 and 504, respectively, in any manner described herein, including by laminating, molding, spraying, etc.

First and second adhesive layers 806 and 808 bond together first, second, and third layers 502, 504, and 506. First adhesive layer 806 may be applied to the second surface of first layer 502, and second adhesive layer 808 may be applied to the second surface of second layer 504. First and second adhesive layers 806 may each be any type of adhesive material described elsewhere herein, including a resin, a foam layer, a glue, an epoxy, etc., and may optionally include micro- and/or nanomaterials. First and second coating layers 802 and 804 may be applied to first and second layers 502 and 504, respectively, in any manner described herein, including by laminating, molding, spraying, etc. When first and second layers 502 and 504 are moved into contact with each other (e.g., by a compression mechanism), first and second adhesive layers 806 and 808 come into contact with each other and bond together first, second, and third layers 502, 504, and 506. Furthermore, first and second adhesive layers 806 and 808 may combine to form a single layer in panel 800.

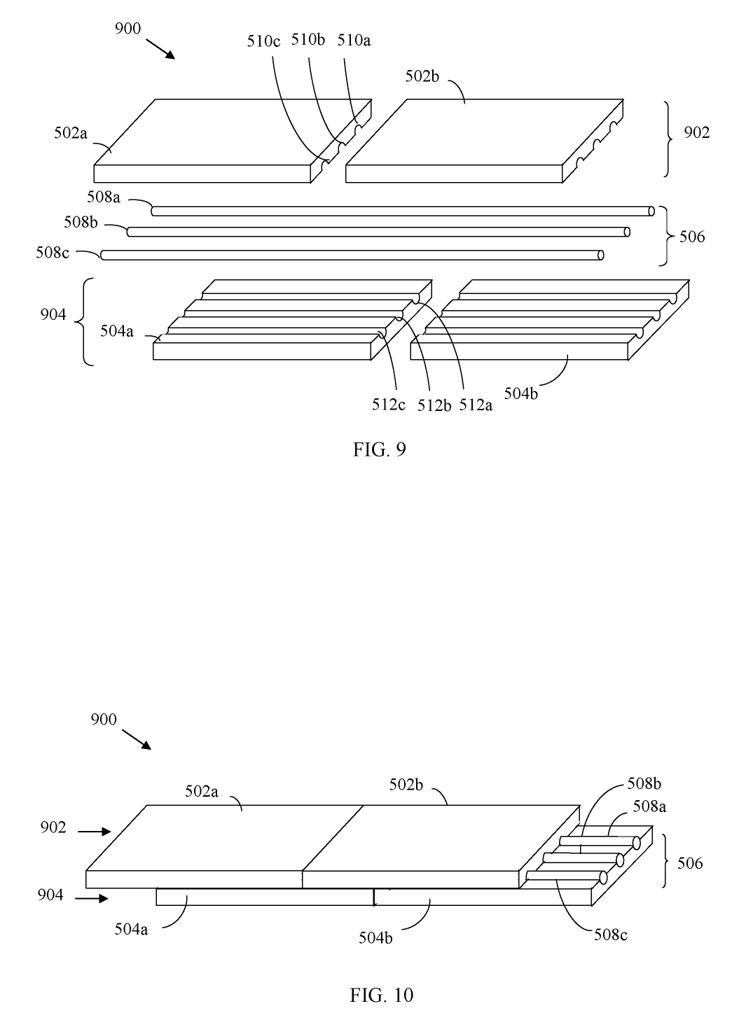

Rods 508 provide additional strength to panels 500, 700, and 800, including strength in tension, compression, and/or torsion with respect to panels 500, 700, and 800. Rods 508 may be textured (e.g., provided with grooves, ridges, etc.) to enhance adhesion with layers 502, 504, and/or 702. Panels 500, 700, and 800, may be combined in any manner to form larger panels. For example, FIG. 9 shows a perspective exploded view of a panel 900, according to an embodiment of the present invention. FIG. 10 shows a perspective side view of panel 900, in non-exploded form. As shown in FIGS. 9 and 10, panel 500 includes a first layer 902, a second layer 904, and third layer 506. First layer 902 includes a plurality of first layers 502 (shown in FIG. 5). Second layer 904 includes a plurality of second layers 504 (shown in FIG. 5). For example, in the embodiment of FIGS. 9 and 10, first layer 902 includes layers 502a and 502b, and second layer includes layers 504a and 504b. In other embodiments, first and second layers 902 and 904 may include further numbers of layers 502 and 504, respectively, to generate panel 900 to have any desired length.

As shown in FIG. 9, layers 502a and 502b are positioned in series to form first layer 902, such that recesses 510 in layers 502a and 502b are aligned with each other. Furthermore, layers 504a and 504b are positioned in series to form second layer 904, such that recesses 512 in layers 504a and 504b are aligned with each other. To form panel 900, rods 508 (e.g., rods 508a-508c) of third layer 506 are positioned between layers 902 and 904, and layers 902 and 904 are moved into contact with each other, with rods 508 fitting into recesses 510 and 512 in layers 502a and 502b and layers 504a and 504b, respectively.

Note that in embodiments, layers 502 in first layer 902 may be aligned in any manner relative to layers 504 in second layer 904. For example, as shown in FIGS. 9 and 10, layers 502 in first layer 902 may be staggered relative to layers 504 in second layer 904. For instance, when panel 900 is formed, layer 502b of first layer 902 may have a first portion in contact with layer 504a and a second portion in contact with layer 504b of layer 904, as shown in FIG. 10. Furthermore, layer 504a of second layer 904 may have a first portion in contact with layer 502a and a second portion in contact with layer 502b of layer 902, as shown in FIG. 10. Such a staggered arrangement of layers 502 and 504 may enable greater adhesion and strength in panel 900. In an alternative embodiment, each layer 502 in first layer 902 may be aligned with a corresponding layer 504 in second layer 904, in a non-staggered arrangement. Furthermore, note that in embodiments, layers 502 in first layer 902 may have different lengths from layers 504 in second layer 904. Furthermore, in embodiments, layers 502 in first layer 902 may have different lengths from each other, and layers 504 in second layer 904 may have different lengths from each other.

### EXAMPLE ASSEMBLY EMBODIMENTS FOR SMART PANELS

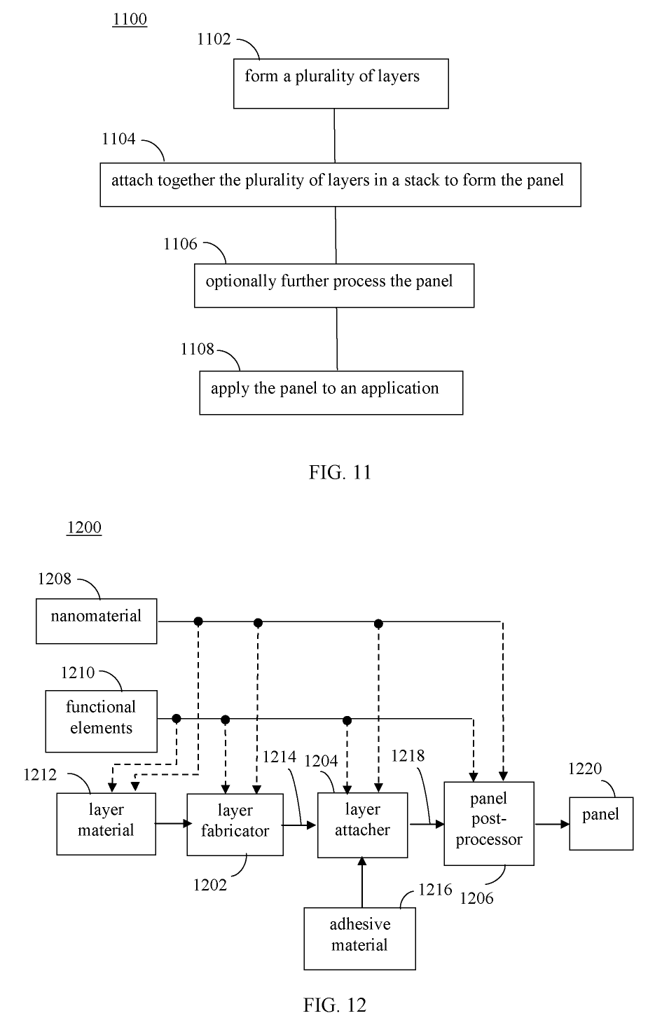

Smart panels may be assembled in a variety of ways, according to embodiments. For instance, FIG. 11 shows a flowchart 1100 for fabricating a smart panel, according to an example embodiment of the present invention. Flowchart 1100 may be performed by a variety of assembly systems, which may incorporate any suitable manual, mechanical, electrical, chemical, and/or other fabrication techniques. For example, FIG. 12 shows a smart panel fabrication system 1200, according to an embodiment of the present invention. For illustrative purposes, flowchart 1100 is described with respect to smart panel fabrication system 1200 shown in FIG. 12. As shown in FIG. 12, system 1200 includes a layer fabricator 1202, a layer attacher 1204, and a panel post-processor 1206. Further structural and operational embodiments will be apparent to persons skilled in the relevant art(s) based on the discussion regarding flowchart 1100. Flowchart 1100 is described as follows.

Flowchart 1100 begins with step 1102. In step 1102, a plurality of layers is formed. For instance, referring to FIG. 12, layer fabricator 1202 may perform step 1102. Layer fabricator 1202 is configured to form one or more layers that may be combined to form a smart panel. As shown in FIG. 12, layer fabricator 1202 receives layer material 1212. Layer material 1212 may include one or more materials used to form layers of a panel. For example, layer material 1212 may include one or more polymers, such as polyurethane, polyester, acrylic, phenolic, epoxy, elastomerics, polyolefins, polypropylene, polyethylene, and/or vinyl ester, a ceramic material, a metal, and/or other layer materials.

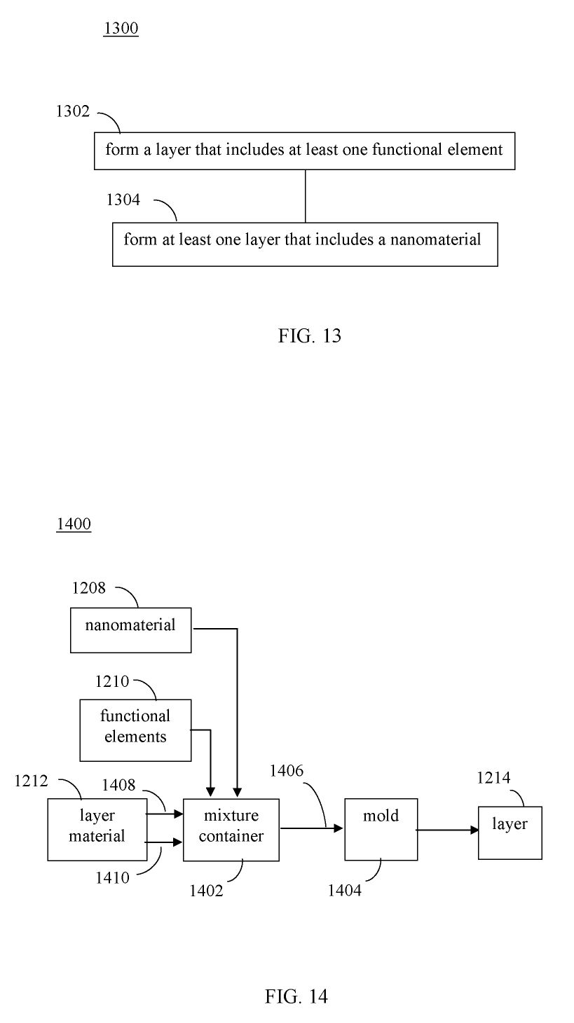

In an embodiment, step 1102 of flowchart 1100 may include one or both of the steps shown in a flowchart 1300 in FIG. 13. In step 1302 of flowchart 1300, a layer is formed that includes at least one functional element. For instance, as shown in FIG. 12, layer fabricator 1202 may optionally receive functional elements 1210, and may incorporate functional elements 1210 in one or more layers. Functional elements 1210 may include one or more (e.g., an array, distributed, etc.) of the functional elements described elsewhere herein, including power generator 302, power storage 304, communication module 306, data storage 308, sensor 310, display 312, microcontroller 314, and environmental control module 316 shown in FIG. 3A, and/or antenna 322, transceiver 324, memory 326, rechargeable battery 328, microcontroller chip 330, display/user interface 332, heating element 334, sensor 336, and/or power generator/storage element 338 shown in FIG. 3B. The particular functional elements included in a layer may be selected based on a particular application for the layer/panel, as would be known to persons skilled in the relevant art(s) from the teachings herein.

In an embodiment where functional elements 1210 is/are received by layer fabricator 1202, one or more of functional elements 1210 may be incorporated into a material of layer material 1212 by layer fabricator 1202 (prior to forming a layer), may be incorporated into a formed layer by layer fabricator 1202, and/or may be applied to a surface of a formed layer by layer fabricator 1202. In embodiments, the one or more functional elements 1210 may be incorporated into a material of layer material 1212 by layer fabricator 1202 in any manner described elsewhere herein or otherwise known, including incorporating the one or more functional elements 1210 into a solid (e.g., powder) or liquid material of layer material 1212 prior to formation of a layer. The one or more functional elements 1210 may be incorporated into a formed layer by layer fabricator 1202 in any manner described elsewhere herein or otherwise known, including by machining, drilling, or otherwise forming an opening in the formed layer and inserting the one or more functional elements into the opening. The one or more functional elements 1210 may be applied to a surface of a formed layer by layer fabricator 1202 in any manner described elsewhere herein or otherwise known, including, including by spraying on, by using an attachment mechanism (e.g., an adhesive material, solder, one or more nails, screws, bolts, etc.), or by other technique.

Referring back to FIG. 13, in step 1304, at least one layer is formed that includes a nanomaterial. For instance, as shown in FIG. 12, layer fabricator 1202 may optionally receive nanomaterial 1208, and may incorporate nanomaterial 1208 in one or more layers. Nanomaterial 1208 may include one or more of the nanomaterials described elsewhere herein, including nanowires, nanorods, nanotubes (e.g., carbon nanotubes), glass fibres, carbon fibres, nanoparticles (e.g., silver nanoparticles), nano silica, nano clay, nano aluminum, nano silver, nano carbon, black oxides, graphene, nano platelets, organic and inorganic nano elements, etc. It is noted that persons skilled in the relevant art(s) would be capable of selecting from a wide variety of nanomaterials, whether or not such materials include the “nano” prefix. The particular nanomaterials included in a layer may be selected based on a particular application for the layer/panel, as would be known to persons skilled in the relevant art(s) from the teachings herein. For example, silver nanoparticles may be included in a layer for bacteria resistance in a medical application. It is also recognized that the nanomaterials may be treated in such as way as to provide additional functionality. Such additional functionality may be stand alone (e.g., nano chemical sensors) or the nanomaterials may interact with other components in a panel to enable a desired functionality (e.g., as in the case of reinforcing fibers, electrical conductivity, or thermal conductivity).

In an embodiment where nanomaterial 1208 is received by layer fabricator 1202, nanomaterial 1208 may be incorporated into a material of layer material 1212 by layer fabricator 1202 in any manner described elsewhere herein or otherwise known. For example, in an embodiment, nanomaterial 1208 may be added to a foam material to be incorporated into a layer.

For instance, FIG. 14 shows a block diagram of a layer fabricator 1400, according to an example embodiment of the present invention. Layer fabricator 1400 is an example of layer fabricator 1202 of FIG. 12. As shown in FIG. 14, layer fabricator 1400 includes a mixture container 1402 and a mold 1404. Mixture container 1402 is a container that receives a first material 1408 of layer material 1212, such as a resin or other layer material. Nanomaterial 1208 and/or functional elements 1210 may optionally be added to mixture container 1402. Mixture container 1402 is configured to mix the combination of first material 1408, functional elements 1210, and nanomaterial 1208. Mixture container 1402 may be configured to perform the mixing in any manner, including by paddle mixing, ultrasonic mixing, milling, shear mixing, agitation, boiling, and/or any other suitable mixing technique, which may be selected based on the particular application. A second material 1410 of layer material 1212 may optionally be received by mixture container 1402. Second material 1410 may be a second resin or other layer material to function as a catalyst to a foaming and/or curing process. Second material 1410 may be mixed with first material 1408, functional elements 1210, and nanomaterial 1208 in mixture container 1402 as described above. Note that the order in which these materials/elements are mixed may be modified/selected to enable particular desired functionalities in the resulting layer(s).

As shown in FIG. 14, mixture container 1402 outputs a mixed layer material 1406, which is received by mold 1404. Mold 1404 is an enclosure having a predefined shape that is a desired shape for a layer being formed by layer fabricator 1400. Further layer materials may be optionally input to mold 1404, including one or more rods (e.g., rods 508 shown in FIG. 5), fibers, ribbons, woven materials (e.g., woven layers 104 and/or 106 shown in FIG. 1) and/or other layer materials described elsewhere herein. The foaming process proceeds in mold 1404, such that mixed layer material 1406 is allowed to foam/expand to fill mold 1404, and to cure/harden into the predetermined shape of the enclosure of mold 1404. If rods, fibers, ribbons, woven materials, and/or further layer materials are present in mold 2404, the foam spreads and hardens around the rods, fibers, ribbons, woven materials, and/or further layer materials. As described above, second material 1410 may cause mixed layer material 1406 to foam. Alternatively, second material 1410 may not be added to mixture container 1402, and mold 1404 may apply heat, pressure, water vapor, or other foaming/curing agent to mixed layer material 1406 to induce the foaming. As shown in FIG. 14, mold 1404 outputs layer 1214, which is formed of the cured material of mixed layer material 1406. Layer 1214 has a shape based on the enclosure of mold 1404.

Note that the example of FIG. 14 is provided for purposes of illustration. Layer fabricator 1202 shown in FIG. 12 may be configured to form layers using a mold (as shown in FIG. 14), such as an injection molding process or a compression molding process, and/or according to other techniques, including an extrusion process, a roll process, a casting process, and/or any other technique used to process polymers and/or other materials into shapes and configurations.

In step 1104, the plurality of layers is attached together in a stack to form the panel. For instance, referring to FIG. 12, layer attacher 1204 may perform step 1104. Layer attacher 1204 receives a plurality of layers 1214 from layer fabricator 1202. Furthermore, layer attacher 1204 may optionally receive one or more functional elements 1210 and/or nanomaterial 1208. Layer attacher 1204 is configured to stack the received plurality of layers 1214 in a predetermined order, and to attach together the plurality of layers 1214 in the stack to form a panel 1218. In an embodiment, layer attacher 1204 may receive an adhesive material 1216. Adhesive material 1216 may be any adhesive material mentioned elsewhere herein or otherwise known, including an epoxy, laminate, a glue, a foam material, a thin film adhesive, and/or other adhesive material. Layer attacher 1204 may be configured to apply adhesive material 1216 to one or more layers and/or between one or more adjacent pairs of layers in the stack. Layer attacher 1204 may apply a compressive force, heat, and/or other curing agent/technique to the stack to cause the plurality of layers 1214 to become attached together to form panel 1218.

Note that in embodiments, a formed panel (e.g., any of panels 100, 300, 320, 400, 700, 800, and 900) may be received by layer attacher 1204 to be stacked and attached to one or more other formed panels and/or layers.

In step 1106, the panel is optionally further processed. For instance, referring to FIG. 12, panel post-processor 1206 may perform step 1106. Panel post-processor 1206 receives panel 1218, and may optionally perform post-processing on panel 1218. For example, panel post-processor 1206 may apply a coating (e.g., as described elsewhere herein) to panel 1218, may shape panel 1218 (e.g., as described elsewhere herein), and/or may otherwise post-process panel 1218. As shown in FIG. 12, panel post-processor 1206 generates panel 1220. In embodiments, panel 1220 may have any configuration of layers described elsewhere herein (e.g., any of panels 100, 300, 320, 400, 700, 800, and 900) or any other number and combination of layers described herein.

In step 1108, the panel is applied to an application. In embodiments, panel 1220 generated by system 1200 may be configured, delivered, and/or applied to be used in any suitable application described elsewhere herein or otherwise known to persons skilled in the relevant art(s) from the teachings herein.

Example Smart Panel Applications

The panel embodiments of FIGS. 1-10, fabrication processes of FIGS. 11 and 13, and fabrication systems of FIGS. 12 and 14 are provided for illustrative purposes, and are not intended to be limiting. Layers of panels, such as panels 100, 300, 320, 400, 700, 800, and 900 may be manufactured/assembled as desired for a particular application. Any number of layers, layer types, layer sizes (e.g., lengths, widths, and thicknesses), and embedded materials/components may be used in a particular panel. Any layer may include any number of one or more functions (e.g., functional elements). A panel may be fabricated having any desired hardness, strength, durability, and functionality, as desired by combining the appropriate layer materials, micro- and/or nanomaterials, functional materials. For instance, one or more foam layers may be provided that include microscale materials, nanomaterials, and/or functional materials to provide functional characteristics desired for a particular panel. One or more woven layers may be provided that provide strength and flexibility for a particular panel. One or more bar layers may be provided that provide greater strength and rigidity for a particular panel. One or more coating layers may be provided that provide environmental protection for a particular panel. These layer types, and further layer types, may be provided to provide any characteristics and functionality described elsewhere herein.

In an embodiment, a panel may be incorporated into a structure such as an automobile, a truck such as a delivery truck, a shipping container, an aircraft skin, wearable armor or accessories (including camouflaged armor), wind turbine blades, and into further structures, including enclosures. Such structures may be newly built with smart panels embodiments, and/or existing structures may be retrofitted with smart panel embodiments. In an embodiment, a panel may be attached to a structure. For example, one or more panels may be attached to an outer surface of an automobile, truck, shipping container, aircraft, wearable armor, other type of container (e.g., a canister that stores a flammable and/or explosive material, such as a fuel, fireworks, ammunition, or other explosive material), or wind turbine blade. Alternatively, a panel may form a portion of the structure. For example, a panel of the present invention may replace a panel of an outer structure of an automobile, truck, shipping container, aircraft, wearable armor, or wind turbine blade. Panels may be flat, curved, contoured, or have any other geometric shape or contour.

Panels formed according to embodiments of the present invention have many applications. For example, panels may be used in applications of homeland security, environmental monitoring, defense, displays, recreational vehicles, inventory management, shipping, infrastructure, construction, transportation, energy generation, storage, distribution, and weather monitoring.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A panel, comprising:
a stack of one or more layers;
a nanomaterial dispersed in a material of at least one layer of the plurality of layers; and
at least one functional element included in a layer of the plurality of layers.

2. The panel of claim 1, wherein the nanomaterial is one or more of a nanowire, a nanotube, a nanorod, or a nanoparticle.

3. The panel of claim 1, wherein a layer in the stack includes at least one of a woven material, a cured foam material, a plurality of solid rods, a plurality of hollow tubes, a chopped matte, or a continuous matte.

4. The panel of claim 1, further comprising an adhesive material between one or more layers in the stack.

5. The panel of claim 1, wherein the at least one functional element includes at least one of a power generator, a data storage element, a power storage element, a communication module, a cooling element, a heating element, a display, or a microcontroller.

6. The panel of claim 1, wherein the at least one functional element includes at least one sensor.

7. The panel of claim 6, wherein the material of the at least one layer is configured to be modified based on a reading provided by the at least one sensor.

8. The panel of claim 6, wherein the at least one sensor is configured to communicate with an entity external to the panel.

9. The panel of claim 1, wherein the at least one function element includes a sensor array distributed throughout the panel.

10. The panel of claim 1, wherein the one or more layers include a layer that configured to provide protection for the panel.

11. The panel of claim 1, wherein at least one of the layers is configured to protect the at least one functional element.

12. The panel of claim 1, wherein the panel is configured as a container, a package, a vehicle component, a protective structure, or a barrier.

13. A panel, comprising:
a stack of one or more layers;
a microscale material dispersed in a material of at least one layer of the plurality of layers; and
at least one functional element included in a layer of the plurality of layers.

14. The panel of claim 13, wherein the microscale material is a microelectromechanical system (MEMS) device.

15. A method of forming a panel, comprising:
forming a plurality of layers, said forming including
forming a layer that includes at least one functional element, and
forming at least one layer that includes a nanomaterial; and
attaching together the plurality of layers in a stack.

16. The method of claim 15, wherein said attaching comprises:
compressing the plurality of layers together to form the stack.

17. The method of claim 15, wherein said attaching comprises:
inserting an adhesive material between layers of the plurality of layers; and
curing the adhesive material.

18. The method of claim 15, wherein said forming a plurality of layers comprises:
forming a layer that includes at least one of a woven material, a ribbon, a plurality of solid rods, or a plurality of hollow tubes.

19. The method of claim 15, wherein said forming a plurality of layers comprises:
combining a resin material and a catalyst material in a mold to cause a foam material to be produced that conforms to the shape of the mold.

20. The method of claim 15, wherein said forming a plurality of layers comprises:
inserting a foamable material into a mold; and
applying a stimulus to cause the foamable material to foam.

21. The method of claim 15, wherein said forming a layer that includes at least one functional element comprises:
forming the layer to include at least one of a power generator, a data storage element, a power storage element, a communication module, a cooling element, a heating element, a display, a microcontroller, or a sensor.

22. The method of claim 21, wherein said forming the layer to include at least one of a power generator, a data storage element, a power storage element, a communication module, a cooling element, a heating element, a display, a microcontroller, or a sensor comprises:
forming the layer to include the power generator, data storage element, power storage element, communication module, cooling element, heating element, display, microcontroller, or sensor distributed throughout the layer.

23. The method of claim 15, wherein said attaching together the plurality of layers in a stack comprises:
positioning in the stack a layer that is configured to provide protection for the panel.

24. The method of claim 15, further comprising:
forming a coating on a surface of a layer in the stack.

25. A panel, comprising:
a layer that includes a nanomaterial dispersed in a material of the layer and at least one functional element included in the layer.
